(19) United States
(12) Patent Application Publication
(10) Pub. No.: US 2006/0177710 A1
(43) Pub. Date: Aug. 10, 2006

(54) Fuel cell

(76) Inventors: Nobuyasu Tajima, Ome-shi (JP); Norihiro Tomimatsu, Mitaka-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/349,426

(22) Filed: Feb. 7, 2006

(30) Foreign Application Priority Data
Feb. 8, 2005 (JP) 2005-032101

(51) Int. Cl. H01M 8/04; H01M 8/12

(52) U.S. Cl. 429/13; 429/26

(57) ABSTRACT

According to one embodiment, a fuel cell includes an electromotive section which generates power based on a chemical reaction, a fuel tank which contains a fuel, an anode line through which the fuel is circulated between the electromotive section and the fuel tank, a cathode line which is connected to the electromotive section and through which products from the electromotive section are discharged, a cooling section which is connected to the cathode line and cools the products to condense water, a water recovery line which guides the water condensed in the cooling section into the fuel tank, and a base manifold which defines a plurality of lines including the anode line and the cathode line.

### CROSS-REFERENCE TO RELATED APPLICATIONS

This application is based upon and claims the benefit of priority from prior Japanese Patent Application No. 2005-032101, filed Feb. 8, 2005, the entire contents of which are incorporated herein by reference.

### BACKGROUND

1. Field

The present invention relates to a fuel cell used as a power source for an electronic device, etc.

2. Description of the Related Art

Presently, a secondary battery, e.g., a lithium ion battery, is mainly used as a power source for electronic devices, such as portable notebook personal computers (notebook PCs), mobile devices, etc. In recent years, high-output miniature fuel cells that require no charging are expected as novel power sources, based on a demand for increased power consumption and prolonged operating time that are required by enhanced functions of the electronic devices. Among various types of fuel cells, a direct methanol fuel cell (DMFC) that uses a methanol solution as its fuel can handle the fuel more easily and has a simpler system than fuel cells that use hydrogen as their fuel. Accordingly, the DMFC is noticed as a promising power source for the electronic devices.

As a fuel cell of this type, one that uses a dilution circulation system is proposed in, for example, Jpn. Pat. Appln. KOKAI Publication No. 2004-95376. What circulates in this system is a low-concentration aqueous methanol solution. High-concentration methanol is resupplied to compensate for the consumption of methanol by power generation, while water that is produced by chemical reaction is recovered to make up for water consumption. To attain this, a mixing tank is provided in which an aqueous methanol solution is produced by mixing the supplied high-concentration methanol and the water. An electromotive section has an anode and a cathode such that power generation is achieved by chemical reaction as diluted methanol and air are supplied to the anode and cathode sides, respectively.

The fuel cell of this type has a number of lines, including an anode line through which an aqueous fuel solution is refluxed between the mixing tank and the electromotive section, a cathode line through which products produced in the anode line and the electromotive section are discharged and refluxed into the electromotive section, etc. These lines are individually formed of pipes that are connected to the individual components.

The fuel cell constructed in this manner has a large number of pipes and its components are connected to one another by these pipes. Thus, the fuel cell requires use of a lot of components and entails a complicated structure and troublesome assembly, including pipe connection. This is not desirable in view of reducing the manufacturing costs and improving the manufacturing efficiency.

### BRIEF DESCRIPTION OF THE SEVERAL VIEWS OF THE DRAWING

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a fuel cell according to an embodiment of the invention;

FIG. 2 is an exemplary perspective view showing the fuel cell connected to a personal computer;

FIG. 3 is an exemplary perspective view showing a power generation section of the fuel cell;

FIG. 4 is an exemplary exploded perspective view showing the power generation section and a base manifold;

FIG. 5 is an exemplary system diagram mainly showing a configuration of the power generation section of the fuel cell;

FIG. 6 is an exemplary view typically showing a cell structure of an electromotive section of the fuel cell;

FIG. 7 is an exemplary exploded perspective view showing the base manifold;

FIG. 8 is an exemplary sectional view of the base manifold;

FIG. 9 is an exemplary sectional view of the base manifold; and

FIG. 10 is an exemplary sectional view showing the base manifold and the mounted electromotive section.

### DETAILED DESCRIPTION

Various embodiments according to the invention will be described hereinafter with reference to the accompanying drawings. In general, according to one embodiment of the invention, a fuel cell comprises an electromotive section which generates power based on a chemical reaction; a fuel tank which contains a fuel; an anode line through which the fuel is circulated between the electromotive section and the fuel tank; a cathode line which is connected to the electromotive section and through which products from the electromotive section are discharged; a cooling section which is connected to the cathode line and cools the products to condense water; a water recovery line which guides the water condensed in the cooling section into the fuel tank; and a base manifold which defines a plurality of lines including the anode line and the cathode line.

A fuel cell according to an embodiment of this invention will now be described in detail with reference to the accompanying drawings.

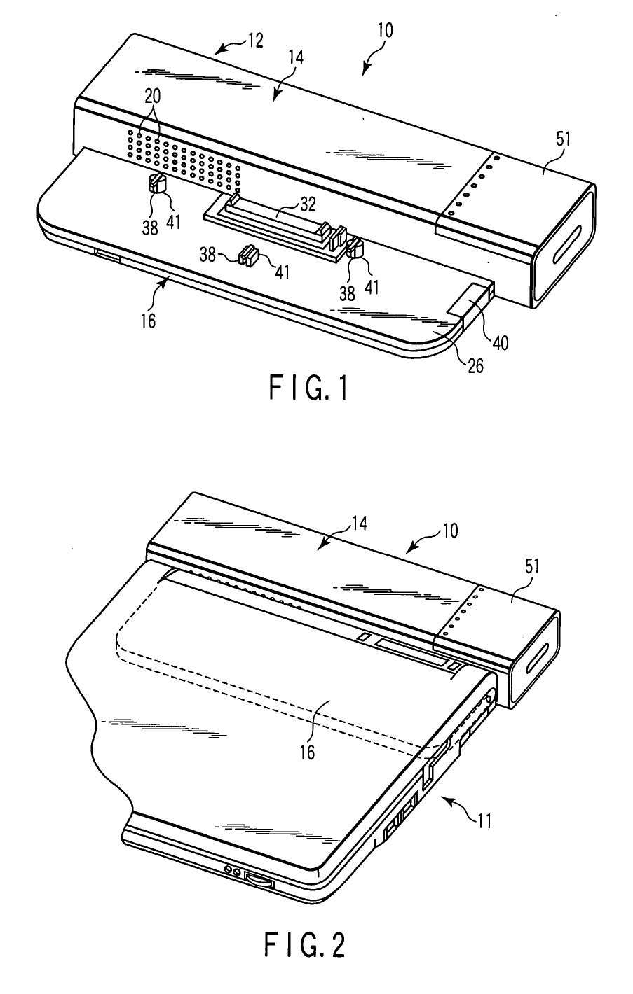

As shown in FIGS. 1 and 2, a fuel cell 10 is constructed as a DMFC that uses methanol as a liquid fuel and is usable as a power source for an electronic device, such as a personal computer 11.

The fuel cell 10 is provided with a case 12. The case 12 has a horizontally extending body 14 substantially in the form of a prism and a bearer portion 16 that extends from the body. The bearer portion 16, which is in the form of a flat rectangle, can carry a rear part of the computer 11. As described later, the body 14 contains therein a fuel tank, electromotive section, mixing tank, etc. A lock mechanism for locking the computer 11 and the like are located on the bearer portion 16.

As shown in FIG. 1, a connector 32 for connection with the personal computer 11 is provided on the upper surface of the bearer portion 16. A connector (not shown) for connection with the connector 32 of the fuel cell 10 is provided on a rear part of, for example, the bottom surface of the computer 11 and is connected mechanically and electrically to the connector 32. Positioning projections 41 and hooks 38 that constitute the lock mechanism are provided on three spots of the bearer portion 16. The positioning projections 41 and the hooks 38 engage the rear part of the bottom surface of the computer 11, thereby positioning and holding the computer 11 on the bearer portion 16. Further, the bearer portion 16 is provided with an eject button 40 that is used to unlock the lock mechanism in disengaging the computer 11 from the fuel cell 10. The bearer portion 16 has therein a control section for controlling the operation of a power generation section, which will be described later.

As shown in FIG. 1, a wall portion of the body 14 is formed with a number of vents including vents 20. As described later, a fuel tank 50 that constitutes the power generation section is constructed as a removable fuel cartridge. One side portion of the body 14 is formed as a cover 51 that can be removed when the fuel tank 50 is detached.

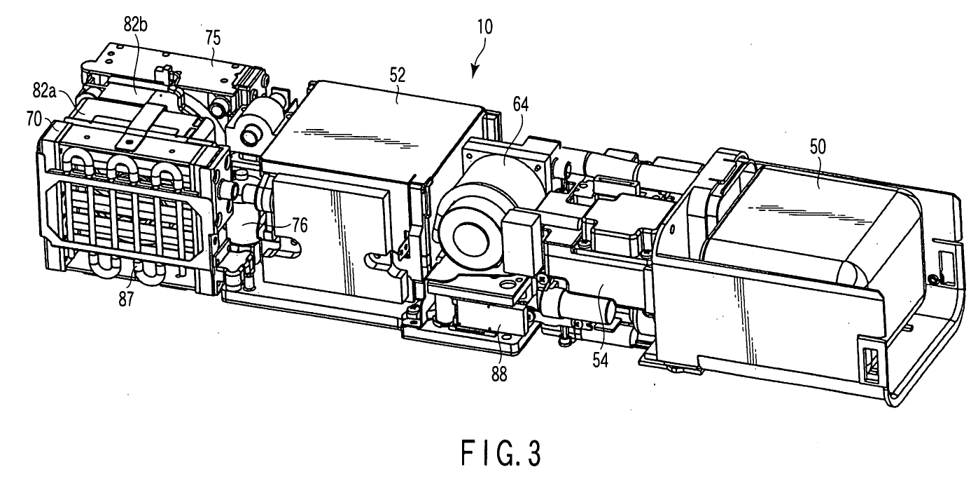

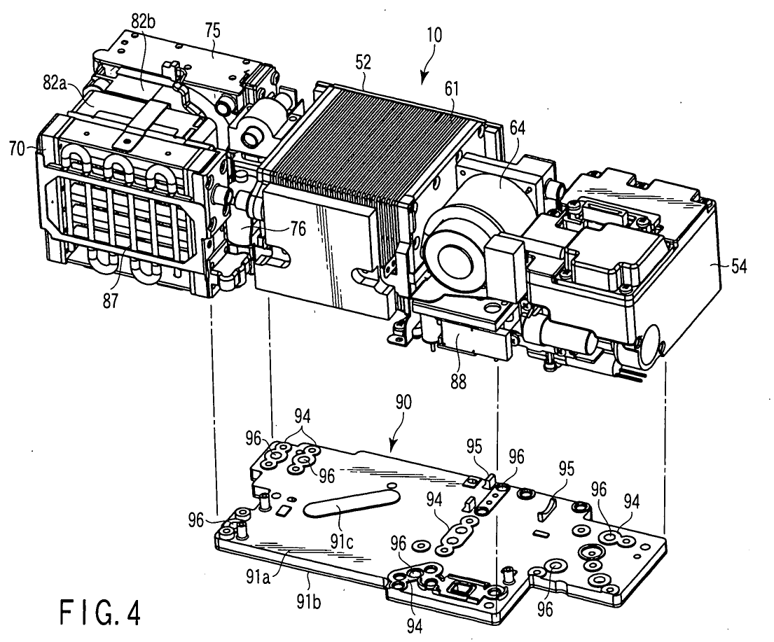

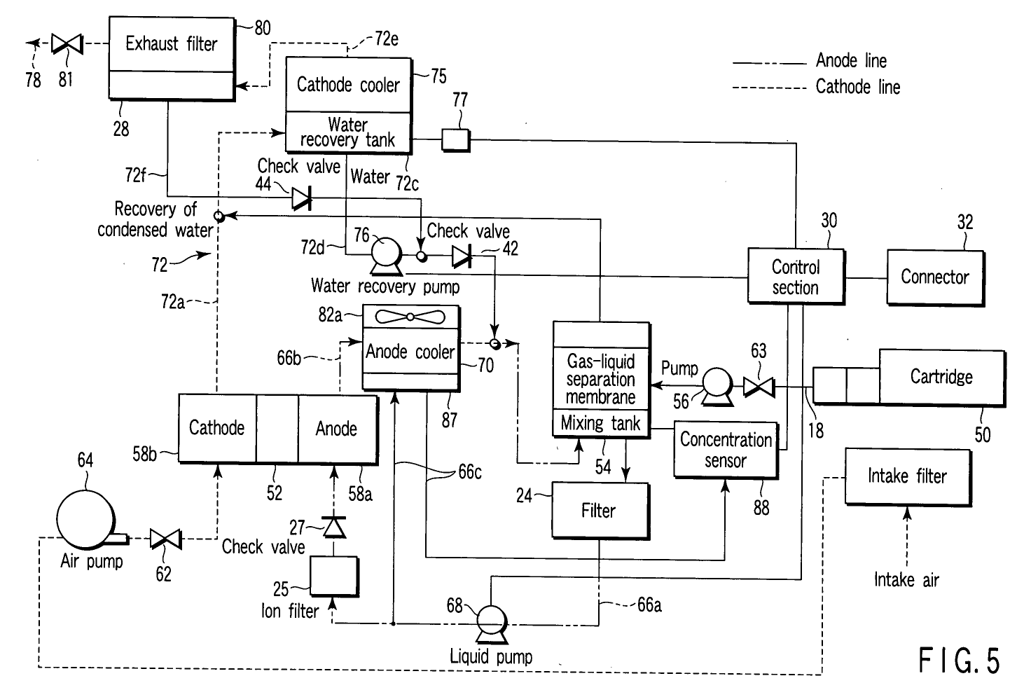

The configuration of the power generation section will now be described in detail. FIGS. 3 and 4 are perspective views individually showing the power generation section, and FIG. 5 is a system diagram mainly showing the power generation section, especially details of an electromotive section 52 formed of a DMFC stack and accessories around it. As shown in FIGS. 3 and 4, the power generation section comprises the fuel tank 50, the electromotive section 52, a mixing tank 54, an anode cooler 70, and a cathode cooler 75. The fuel tank 50 is provided in one side portion of the body 14. The electromotive section 52 is located in the central part of the body 14 and performs power generation based on a chemical reaction. The mixing tank 54 is disposed between the electromotive section and the fuel tank. The coolers 70 and 75 are arranged in the other side portion of the body. The fuel tank 50 contains high-concentration methanol for use as a liquid fuel. The tank 50 is formed as a cartridge that can be attached to and detached from the body 14.

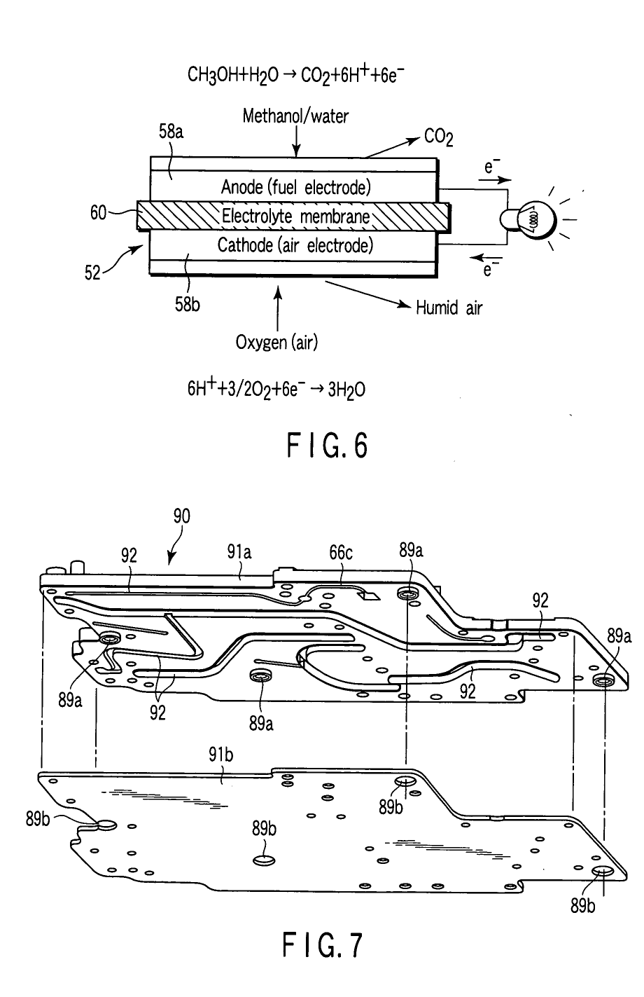

As shown in FIG. 5, the fuel tank 50 is connected to the mixing tank 54 by a fuel supply line 18, which is provided with a first liquid pump 56, which feeds a fuel from the fuel tank into the mixing tank, and a solenoid valve 63. As shown in FIG. 6, the electromotive section 52 is formed by stacking cells in layers. Each cell is formed of an anode (fuel electrode) 58a, a cathode (air electrode) 58b, and an electrolyte membrane 60 sandwiched between the electrodes. As shown in FIG. 4, a large number of cooling fins 61 are arranged around the electromotive section 52.

As shown in FIGS. 3 to 5, the power generation section is provided with an air pump 64, which supplies air to the cathode 58b of the electromotive section 52 through an air valve 62. The air pump 64 constitutes an air supply section. A fuel supply line 66a and a fuel recovery line 66b are connected between the electromotive section 52 and the mixing tank 54, and form an anode line through which the fuel is circulated between the anode 58a of the electromotive section and the tank 54. The fuel supply line 66a is connected with a filter 24, a second liquid pump 68, an ion filter 25, and a check valve 27. The pump 68 delivers the fuel from the mixing tank 54 to the electromotive section 52.

The anode cooler 70 is connected to a middle part of the fuel recovery line 66b. The cooler 70 has a pipe (not shown) that is connected to the fuel recovery line 66b and a large number of radiator fins around the pipe. Further, the anode cooler 70 has a first cooling fan 82a. The fan 82a sucks cooling air into the body through its vents 20, thereby circulating the cooling air around the anode cooler 70 and then discharging it into the body.

The electromotive section 52 is connected with a cathode line through which air and products of power generation are discharged from the cathode 58b. The cathode cooler 75 for cooling the products and air flowing through the cathode line is connected to a middle part of the cathode line. The cooler 75 has a plurality of pipes (not shown) extending individually at angles to the horizontal direction, a large number of cooling fins around the pipes, and a reservoir portion (water recovery tank) 72c. The reservoir portion 72c receives and stores water condensed in the pipes and water discharged from the electromotive section 52.

The cathode line includes a first line 72a, a first recovery line 72d, and a second line 72e. The first line 72a extends from the electromotive section 52 to the cathode cooler 75. The first recovery line 72d guides the water stored in the reservoir portion 72c into the mixing tank 54. The second line 72e opens into the upper end of the cathode cooler 75. The first recovery line 72d communicates with the fuel recovery line 66b between the anode cooler 70 and the mixing tank 54, and is connected to the mixing tank by the fuel recovery line. The second line 72e is provided with an exhaust port 78 that opens toward the vents of the body 14.

The first recovery line 72d is connected with a water recovery pump 76, which supplies the water in the reservoir portion 72c to the mixing tank 54. Further, the reservoir portion 72c contains therein a water level sensor 77 for detecting the level of the water stored in the reservoir portion.

In the second line 72e, an exhaust filter 80 and an exhaust valve 81 are located near the exhaust port 78. The exhaust filter 80 is formed of, for example, a metal catalyst or the like and serves to remove toxic substances such as methanol in the air that is discharged through the cathode line. A water recovery portion 28 is provided vertically under the exhaust filter 80 and communicates with the second line 72e. Further, the cathode line has a second recovery line 72f through which the water recovered in the water recovery portion 28 is led to the first recovery line 72d. The second recovery line 72f is connected to the first recovery line 72d between the water recovery pump 76 and the mixing tank 54.

Between the water recovery pump 76 and the mixing tank 54, the first recovery line 72d is provided with a check valve 42 that restrains the water from flowing back from the mixing tank 54 toward the pump 76. Between the check valve 42 and the water recovery portion 28, the second recovery line 72f is provided with a check valve 44 that restrains the water from flowing back from the pump 76 to the water recovery portion 28.

As shown in FIGS. 3 and 4, the cathode cooler 75 is opposed to the anode cooler 70 with a gap between them. A second cooling fan 82b, a centrifugal fan, is located between the anode cooler 70 and the cathode cooler 75 so as to face the cathode cooler. The fan 82b sucks cooling air into the body through the vents, thereby circulating the cooling air around the cathode cooler 75 and then discharging it into the body.

As shown in FIGS. 3 to 5, the power generation section is provided with a concentration sensor 88 for detecting the concentration of the fuel stored in the mixing tank 54 and a fuel cooling section 87 for cooling the fuel delivered to the concentration sensor. Between the mixing tank 54 and the electromotive section 52, a branch diverges from the fuel supply line 66a and is provided with a branch line 66c through which an aqueous solution of methanol is refluxed into the mixing tank 54 through the branch. The branch line 66c is a dedicated line that serves for the detection of the methanol concentration of the methanol solution. The branch line 66c is provided with the concentration sensor 88 that detects the fuel connection of the methanol solution. For example, a sonic sensor is used as the concentration sensor 88.

Between the branch of the fuel supply line 66a and the concentration sensor 88, the branch line 66c is connected with the fuel cooling section 87 that cools the aqueous methanol solution delivered to the sensor. The cooling section 87 is formed integrally with the anode cooler 70. It is formed by tucking a pipe like a bellows and adjacently opposed to the cooler 70. The cooling section 87 is located in a line for a cooling air flow that is formed by the anode cooler 70 so as to be situated on the upstream side of the cooler 70 with respect to the cooling air flow. In this manner, the fuel cooling section 87 is incorporated in the cooling air flow line so that it can be cooled by utilizing the cooling capacity of the cooler 70. The methanol solution that flows through the branch line 66c can be cooled to, for example, 40° C. or less by the cooling section 87 and delivered to the concentration sensor 88. Thus, the resolution of the concentration sensor 88 is prevented from being lowered by heat.

As shown in FIG. 5, the first and second liquid pumps 56 and 68, air pump 64, water recovery pump 76, air valve 62, exhaust valve 81, and cooling fans 82, which constitute the power generation section, are connected electrically to a control section 30 and individually output detection signals to the control section. Further, the liquid pumps 56 and 68, air pump 64, water recovery pump 76, air valve 62, and exhaust valve 81 constitute an accessory that runs the fluids, including the aqueous methanol solution, water, air, etc., into the lines and adjust the respective flow rates of the fluids.

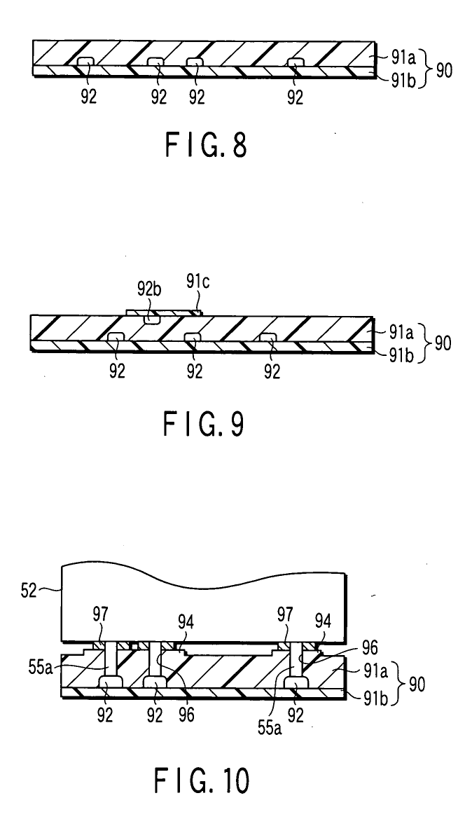

In the fuel cell 10, the lines through which the fluids are run are defined by a base manifold 90. As shown in FIGS. 4, 7, 8 and 9, the manifold 90 has a substantially rectangular base substrate 91a and a plate-shaped cover member 91b that have substantially the same dimensions. A plurality of elongate grooves 92 are formed in the lower surface (first surface) of the base substrate 91a. The cover member 91b is laminated on the lower surface of the base substrate 91a and covers the grooves 92. These grooves 92 form a plurality of lines that include the cathode line and the anode line.

The base substrate 91a and the cover member 91b are formed of, for example, a synthetic resin and are joined together by welding, such as laser welding, thermal welding, or ultrasonic welding. In doing this, those regions of the cover member 91b and the base substrate 91a which are situated on the opposite sides of each groove 92 are welded together throughout the length of the groove. Further, the respective peripheral edge portions of the cover member 91b and the base substrate 91a are welded together at a plurality of spots. If the base substrate 91a and the cover member 91b are joined together with use of an adhesive from which impurities come out, the impurities sometimes may merge into the fuel that flows through the lines, possibly resulting in a reduction in performance. According to the present embodiment, eluation of the impurities can be prevented by joining the cover member 91b and the base substrate 91a by welding.

A plurality of positioning protrusions 89a protrude from the lower surface of the base substrate 91a. The cover member 91b is formed having positioning holes 89b in which the protrusions 89a are to be fitted. The cover member 91b is positioned in place with respect to the base substrate 91a with the positioning protrusions 89a individually in engagement with the positioning holes 89b.

In forming a line that extends across the grooves 92 on the underside of the base substrate 91a, as shown in FIGS. 4 and 9, a groove 92b is formed in the upper surface (second surface) of the base substrate 91a, and a plate-shaped partial cover 91c is laminated on the upper surface of the base substrate so as to cover the groove 92b. The groove 92b forms the line. The partial cover 91c is joined to the base substrate 91a by welding.

As shown in FIGS. 4 and 10, a plurality of communication holes 96 are formed in the base substrate 91a. Each communication hole 96 communicates with its corresponding groove 92 in a predetermined position and opens in the upper surface of the base substrate 91a. A plurality of mount seats 94 protrude from the upper surface of the base substrate 91a and are situated individually around the holes 96. Lugs 95 for supporting accessories, such as pumps, are formed on the upper surface of the base substrate 91a.

The base manifold 90 constructed in this manner is located on the bottom side of the power source section. The components of the power source section, e.g., the mixing tank 54, electromotive section 52, anode cooler 70, cathode cooler 75, first and second cooling fans 82a and 82b, and pumps, are mounted on the base substrate 91a of the base manifold 90 and supported integrally by the base manifold.

Further, the components including the mixing tank 54, electromotive section 52, anode cooler 70, and cathode cooler 75 are connected to the lines of the base manifold 90. The following is a description of the electromotive section 52 as a typical component. As shown in FIG. 10, the electromotive section 52 has a plurality of connecting pipes 55a protruding from its bottom toward the base manifold 90. The electromotive section 52 is placed on the mount seats 94 with the connecting pipes 55a inserted in their corresponding communication holes 96 of the base manifold 90. Each connecting pipe 55a extends to its corresponding groove 92 and communicates with each corresponding line. An O-ring 97 for use as a seal member is located around each connecting pipe 55a and sandwiched between each mount seat 94 and the bottom of the electromotive section 52. The electromotive section 52 is fixed to the base manifold 90 by screwing, for example. Thus, it is mounted on the base manifold 90 and connected to the lines of the base manifold.

The mixing tank 54, anode cooler 70, and cathode cooler 75 are mounted on the base manifold 90 with use of structures similar to those for the electromotive section 52 and connected to the predetermined lines defined by the base manifold. In assembling the power source section, its components are previously formed as a plurality of units. For example, a unit including the anode cooler 70, cathode cooler 75, and first and second cooling fans 82a and 82b, a unit including the electromotive section 52 and its peripheral accessories, and a unit including the mixing tank 54 and its peripheral accessories are prepared. These units are connected together by being successively fixedly mounted on the base manifold 90. Alternatively, the units may be mounted on the base manifold 90 after they are previously connected to one another into a single unit.

If the fuel cell 10 constructed in this manner is used as the power source for the personal computer 11, the rear end portion of the computer is first placed on the bearer portion 16 of the fuel cell, locked in a predetermined position, and connected electrically to the fuel cell. In this state, a switch (not shown) is turned on to start power generation in the fuel cell 10.

In this case, high-concentration methanol is supplied from the fuel tank 50 to the mixing tank 54 by the first liquid pump 56 and mixed with water as a solvent refluxed from the electromotive section 52, whereby it is diluted to a given concentration. The aqueous methanol solution diluted in the mixing tank 54 is supplied through the anode line to the anode 58a of the electromotive section 52 by the second liquid pump 68. On the other hand, air is supplied to the cathode 58b of the electromotive section 52 by the air pump 64. As shown in FIG. 6, the supplied methanol and water chemically react with each other in the electrolyte membrane 60 between the anode 58a and the cathode 58b, whereupon electric power is generated between the anode and the cathode. The power generated in the electromotive section 52 is supplied to personal computer 11 through the control section 30 and the connector 32.

With the progress of the power generation reaction, carbon dioxide and water are produced as reaction products on the sides of the anode 58a and the cathode 58b, respectively, in the electromotive section 52. The carbon dioxide produced on the anode side and an unaffected portion of the methanol are delivered to the anode line, cooled through the anode cooler 70, and then refluxed into the mixing tank 54. The carbon dioxide is gasified in the mixing tank 54 and discharged to the outside through the cathode cooler 75, exhaust valve 81, and finally, the exhaust port 78.

Most of the water produced on the side of the cathode 58b is reduced to steam, which is discharged together with air into the cathode line. The discharged water and steam pass through the first line 72a, and the water is fed into the reservoir portion 72c. Further, the steam and air are delivered to the cathode cooler 75, in which the steam is cooled and condensed. The water produced by the condensation is recovered into the reservoir portion 72c. The water recovered in the reservoir portion 72c is delivered to the mixing tank 54 by the water recovery pump 76, mixed with the methanol, and supplied again to the electromotive section 52.

Some of the air and steam delivered to the second line 72e is fed into the water recovery portion 28. As this is done, the steam is condensed into water in the second line 72e, and the resulting water is recovered into the water recovery portion 28. The air and the methanol splashed in the air are delivered to the exhaust filter 80, whereupon the methanol is removed by the filter. The air passes through the exhaust valve 81 and is discharged into the body 14 through the exhaust port 78, and moreover, to the outside through the vents 20 of the body. The carbon dioxide discharged from the anode side of the electromotive section 52 passes through the second line 72e and is discharged into the body 14 through the exhaust port 78, and moreover, to the outside through the vents 20 of the body.

During the operation of the fuel cell 10, the first and second cooling fans 82a and 82b are driven so that the outside air is introduced into the body 14 through the vents 20 of the body. The outside air introduced into the body 14 through the vents 20 and the air in the body 14 pass around the fuel cooling section 87 and the anode cooler 70, thereby cooling them, and are then sucked in by the first cooling fan 82a. The outside air introduced into the body 14 by the second cooling fan 82b and the air in the body 14 pass around the cathode cooler 75, thereby cooling it, and are then sucked in by the second cooling fan 82b. Further, the air discharged from the first and second cooling fans 82a and 82b cools the electromotive section 52 and its surroundings and is then discharged to the outside of the body 14.

The concentration of the methanol in the mixing tank 54 is detected by the concentration sensor 88. Based on the detected concentration, the control section 30 actuates the water recovery pump 76 to supply the water in the reservoir portion 72c to the mixing tank 54, thereby keeping the methanol concentration constant. Further, the amount of water recovered in the cathode line, that is, the amount of condensed steam, is adjusted by controlling the cooling capacity of the cathode cooler 75, depending on the level of the water recovered in the reservoir portion 72c. In this case, the cooling capacity of the cathode cooler 75 is adjusted by controlling the driving voltage of the second cooling fan 82b according to the water level detected by the water level sensor 77. By doing this, the amount of water recovery is controlled.

As the water is recovered, the water recovery pump 76 is rotated forward by the control section 30. Thereupon, the check valve 42 opens, and the check valve 44 closes. The water in the reservoir portion 72c is delivered to the mixing tank 54 via the first recovery line 72d and the check valve 42.

The control section 30 drives the water recovery pump 76 for reverse rotation for a given time at every given operating period, whereupon the water collected in the water recovery portion 28 is recovered into the reservoir portion 72c. Thus, when the water recovery pump 76 is reversed, the check valve 44 opens, and the check valve 42 closes. The water collected in the water recovery portion 28 and the water produced by condensation in the second line 72e are recovered into the reservoir portion 72c through the second recovery line 72f, check valve 44, and the first recovery line 72d. Thereafter, the recovered water is supplied to the mixing tank 54 and used for the dilution of the methanol.

According to the fuel cell 10 constructed in this manner, a plurality of lines are defined and unitized by the plate-like base manifold 90, so that independent pipes for the formation of the lines can be reduced in number. In consequence, the number of components can be reduced to lower the manufacturing costs and improve the manufacturing efficiency. The base manifold 90 is a simple structure that is formed by pasting together two plates with grooves and can be manufactured at low cost.

Further, the base manifold 90 doubles as a supporting substrate on which the components of the power source section are mounted and supported. In this case, the components and the lines of the base manifold 90 can be connected by only a simple operation such that the connecting pipes are inserted individually into the communication holes of the base manifold. Thus, the assembly of the power source section, such as the line connection, can be performed with ease, so that the manufacturing costs can be reduced, and the manufacturing efficiency can be improved. Consequently, the fuel cell can be obtained having a simple structure and improved assemblability.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

In the present embodiment, the power generation section comprises the fuel tank and the mixing tank. Alternatively, however, the fuel tank may be used to double as the mixing tank that is to be omitted. In the present invention, the fuel tank is shown as a container that contains and supplies the fuel and as including the fuel tank and/or the mixing tank.

The lines that are formed in the base manifold are not limited to the cathode and anode lines but may be modified variously as required. Although the power generation section includes the fuel tank 50, mixing tank 54, electromotive section 52, anode cooler 70, and cathode cooler 75 that are arranged in the order named, the arrangement of these elements may be modified variously as required. In the embodiment described above, the mixing tank 54, electromotive section 52, anode cooler 70, and cathode cooler 75 are mounted on the base manifold. Alternatively, however, at least one of them may be configured to be mounted on the base manifold.

The fuel cell according to this invention may be also used as a power source for any other electronic devices than the personal computer, such as mobile devices, portable terminals, etc. The type of fuel cell is not limited to the DMFC but may be any other type, such as a PEFC (polymer electrolyte fuel cell).

What is claimed is:

1. A fuel cell comprising:
an electromotive section which generates power based on a chemical reaction;
a fuel tank which contains a fuel;
an anode line through which the fuel is circulated between the electromotive section and the fuel tank;
a cathode line which is connected to the electromotive section and through which products from the electromotive section are discharged;
a cooling section which is connected to the cathode line and cools the products to condense water;
a water recovery line which guides the water condensed in the cooling section into the fuel tank; and
a base manifold which defines a plurality of lines including the anode line and the cathode line.

2. The fuel cell according to claim 1, wherein the base manifold is in the form of a plate, and the electromotive section, fuel tank, and/or cooling section is mounted on the base manifold.

3. The fuel cell according to claim 1, wherein the base manifold comprises a base substrate having a first surface and a second surface, a plurality of grooves which are formed on the first surface of the base substrate and define the lines, individually, and a plate-shaped cover member which is overlapped on the first surface of the base substrate and covers the grooves.

4. The fuel cell according to claim 3, wherein the base substrate has a groove which is formed in the second surface of the base substrate and defines a line and a partial cover which is overlapped on the second surface and covers the groove.

5. The fuel cell according to claim 3, wherein the base substrate and the cover member are joined to each other around the grooves by welding.

6. The fuel cell according to claim 3, wherein the base substrate has a plurality of mount seats formed on the second surface and a plurality of communication holes which communicate individually with the lines and open in those positions on the second surface which correspond to the mount seats, and the electromotive section, fuel tank, and/or cooling section is placed on the mount seats and connected to the lines through the communication holes.

7. The fuel cell according to claim 6, wherein the electromotive section, fuel tank, and/or cooling section has a connecting pipe extending toward the base manifold, the connecting pipe being inserted in the communication hole of the base manifold and connected to the line.
